(19) United States
(12) Patent Application Publication
(10) Pub. No.: US 2023/0021555 A1
(43) Pub. Date: Jan. 26, 2023

(54) MODEL TRAINING BASED ON PARAMETERIZED QUANTUM CIRCUIT

(71) Applicant: BEIJING BAIDU NETCOM SCIENCE TECHNOLOGY CO., LTD., BEIJING (CN)

(72) Inventors: Xin WANG, Beijing (CN); Guangxi LI, Beijing (CN); Xuanqiang ZHAO, Beijing (CN)

(21) Appl. No.: 17/945,975

(22) Filed: Sep. 15, 2022

(30) Foreign Application Priority Data
Sep. 17, 2021 (CN) 202111095151.6

(51) Int. Cl. G06N 10/60

(52) U.S. Cl. CPC G06N 10/60

(57) ABSTRACT

A method includes: obtaining training texts; for each of the training texts, performing the following operations: obtaining a word vector of each word in the current training text as a parameter of a first quantum circuit to obtain quantum states; inputting each of the quantum states to second, third, and fourth quantum circuits and performing measurement; calculating one group of weight values corresponding to each word to obtain a feature vector corresponding to the current training text; inputting the feature vector to a neural network model to obtain a prediction value; and determining a value of loss function based on the prediction value and a label value, and adjusting parameters corresponding to the second, third, and fourth quantum circuits and the neural network model based on the value of the loss function.

### CROSS REFERENCE TO RELATED APPLICATIONS

The present application claims priority to Chinese Patent Application No. 202111095151.6 filed on Sep. 17, 2021, the contents of which are hereby incorporated by reference in their entirety for all purposes.

### TECHNICAL FIELD

The present disclosure relates to the field of quantum computing, and in particular, to the field of deep learning and natural language processing technologies, and particularly relates to a model training method and apparatus based on parameterized quantum circuits, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, and machine learning/deep learning, big data processing technologies, and knowledge graph technologies.

Recently, with rapid development of quantum computers, more quantum computers are produced on a large scale and become practical. Quantum machine learning is a critical interdisciplinary frontal orientation that integrates quantum computation and artificial intelligence.

At present, the quantum machine learning has been proved to be widely applied in data classification, combinational optimization, quantum chemistry, and other orientations. How to accomplish a task of quantum artificial intelligence by using quantum resources in combination with computing power of a classical computer is an urgent problem to be solved for promoting breakthrough development of the quantum machine learning and even the entire quantum computation field. Recently, among increasing quantum machine learning algorithms and applications thereof that continuously emerge, quantum natural language processing (QNLP) is a critical orientation.

However, limitations of recent quantum devices result in an unsatisfactory actual effect of applying an existing QNLP model to text classification. In addition, how to exert a quantum computation capability for a natural language processing task such as text classification is also a challenging and critical orientation at present.

### SUMMARY

The present disclosure provides a model training method and apparatus based on parameterized quantum circuits, an electronic device, a computer-readable storage medium, and a computer program product.

According to an aspect of the present disclosure, there is provided a model training method, the method including: obtaining one or more training texts, wherein each of the training texts comprises a label value and one or more words; determining a first parameterized quantum circuit, a second parameterized quantum circuit, a third parameterized quantum circuit, and a fourth parameterized quantum circuit, the second parameterized quantum circuit, the third parameterized quantum circuit, and the fourth parameterized quantum circuit each corresponding to a query-key-value space of a self-attention mechanism; for each of the one or more training texts, performing operations including: obtaining a word vector of each word in a current training text, wherein a dimension of the word vector is same as a dimension of a parameter of the first parameterized quantum circuit, and wherein the current training text comprises Sₘ words, and Sₘ is a positive integer; using each of the word vectors as a parameter of the first parameterized quantum circuit to obtain Sₘ quantum states based on the first parameterized quantum circuit; inputting each of the Sₘ quantum states to the second, third, and fourth parameterized quantum circuits respectively and performing measurement on their outputs respectively to obtain corresponding measurement results; calculating a group of weight values corresponding to each word based on the measurement results corresponding to the second and third parameterized quantum circuits, wherein the group of weight values are in a one-to-one correspondence to the measurement results corresponding to the fourth parameterized quantum circuit; obtaining a feature vector corresponding to the current training text based on Sₘ groups of weight values and the measurement results corresponding to the fourth parameterized quantum circuit; inputting the feature vector to a neural network model to obtain a prediction value; and determining a value of a first loss function based on the prediction value and the label value corresponding to the current training text; determining a value of a second loss function based on the value of the first loss function corresponding to at least one of the one or more training texts; and adjusting, based on the value of the second loss function, the parameters corresponding to the second, third, and fourth parameterized quantum circuits and the parameters corresponding to the neural network model to minimize the value of the second loss function.

According to an aspect of the present disclosure, there is provided a text recognition method, including: determining each word in a text to be recognized and a word vector of the each word; using the word vector of the each word as a parameter of a first parameterized quantum circuit to obtain a quantum state corresponding to the each word, wherein a dimension of a parameter of the first parameterized quantum circuit is same as a dimension of the word vector; inputting the quantum state corresponding to the each word to a second parameterized quantum circuit, a third parameterized quantum circuit, and a fourth parameterized quantum circuit and separately performing measurement to separately obtain corresponding measurement result; determining a feature vector of the text to be recognized based on the measurement results; and inputting the feature vector to a neural network model to obtain a recognition result where the second, third, and fourth parameterized quantum circuits and the neural network model are trained by using the method according to an aspect of the present disclosure.

According to an aspect of the present disclosure, there is provided an electronic device, including: a memory storing one or more programs configured to be executed by one or more processors, the one or more programs including instructions for causing the electronic device to perform operations comprising: obtaining one or more training texts, wherein each of the training texts comprises a label value and one or more words; determining a first parameterized quantum circuit, a second parameterized quantum circuit, a third parameterized quantum circuit, and a fourth parameterized quantum circuit, the second parameterized quantum circuit, the third parameterized quantum circuit, and the fourth parameterized quantum circuit each corresponding to a query-key-value space of a self-attention mechanism; for each of the one or more training texts, performing operations including: obtaining a word vector of each word in a current training text, wherein a dimension of the word vector is same as a dimension of a parameter of the first parameterized quantum circuit, and wherein the current training text comprises Sₘ words, and Sₘ is a positive integer; using each of the word vectors as a parameter of the first parameterized quantum circuit to obtain Sₘ quantum states based on the first parameterized quantum circuit; inputting each of the Sₘ quantum states to the second, third, and fourth parameterized quantum circuits respectively and performing measurement on their outputs respectively to obtain corresponding measurement results; calculating a group of weight values corresponding to each word based on the measurement results corresponding to the second and third parameterized quantum circuits, wherein the group of weight values are in a one-to-one correspondence to the measurement results corresponding to the fourth parameterized quantum circuit; obtaining a feature vector corresponding to the current training text based on Sₘ groups of weight values and the measurement results corresponding to the fourth parameterized quantum circuit; inputting the feature vector to a neural network model to obtain a prediction value; and determining a value of a first loss function based on the prediction value and the label value corresponding to the current training text; determining a value of a second loss function based on the value of the first loss function corresponding to at least one of the one or more training texts; and adjusting, based on the value of the second loss function, the parameters corresponding to the second, third, and fourth parameterized quantum circuits and the parameters corresponding to the neural network model to minimize the value of the second loss function.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The drawings show embodiments by way of example and form a part of the specification, and are used to explain example implementations of embodiments together with a written description of the specification. Embodiments shown are merely for illustrative purposes and do not limit the scope of the claims. Throughout the drawings, identical reference signs denote similar but not necessarily identical elements.

FIG. 1 is a schematic diagram of an example system in which various methods described herein can be implemented according to an embodiment of the present disclosure;

FIG. 2 is a flowchart of a model training method based on parameterized quantum circuits according to an embodiment of the present disclosure;

FIG. 3 is a schematic structural diagram of a parameterized quantum circuit according to an embodiment of the present disclosure;

FIG. 4 is a flowchart of performing measurement on quantum states corresponding to corresponding parameterized quantum circuits according to an embodiment of the present disclosure;

FIG. 5 is a schematic diagram of obtaining corresponding feature vectors based on word vectors according to an embodiment of the present disclosure;

FIG. 6 is a schematic structural diagram of a multi-layer quantum self-attention network according to an embodiment of the present disclosure;

FIG. 7 is a flowchart of a text recognition method according to an embodiment of the present disclosure;

FIG. 8 is a structural block diagram of a model training apparatus based on parameterized quantum circuits according to an embodiment of the present disclosure;

FIG. 9 is a structural block diagram of a text recognition apparatus according to an embodiment of the present disclosure; and FIG. 10 is a structural block diagram of an example electronic device that can be used to implement an embodiment of the present disclosure.

### DETAILED DESCRIPTION

Embodiments of the present disclosure are described below in conjunction with the accompanying drawings, where various details of embodiments of the present disclosure are included to facilitate understanding, and should only be considered as an example. Therefore, those of ordinary skill in the art should be aware that various changes and modifications can be made to embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

So far, various different types of computers in application all use classical physics as a theoretical basis for information processing, and are referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the inevitable disadvantages as follows. 1. Most basic limitation of energy consumption in a computation process. Minimum energy required by a logic element or a storage unit should be several times more than kT to avoid malfunction under thermal fluctuations. 2. Information entropy and heating energy consumption 3. Under a very high routing density of computer chips, according to the Heisenberg's uncertainty principle, if uncertainty of electronic positions is very low, uncertainty of a momentum being very high. Electrons are no longer bound and this have a quantum interference effect. Such an effect may even damage performance of chips.

Quantum computers are a type of physical devices that abide by the properties and laws of quantum mechanics to perform high-speed mathematical and logical computation, and store and process quantum information. When a device processes and computes quantum information and runs a quantum algorithm, the device is a quantum computer. The quantum computers abide by a unique quantum dynamics law (especially quantum interference) to implement a new mode of information processing. For parallel processing of computing problems, the quantum computers have an absolute advantage in speed than classical computers. A transformation of each superposition component performed by the quantum computers is equivalent to a classical computation. All these classical computations are completed simultaneously and superposed based on a specific probability amplitude, and an output result of the quantum computers is provided. Such computation is referred to as a quantum parallel computation. Quantum parallel processing greatly improves efficiency of the quantum computers and causes the quantum computers to complete operations that classical computers cannot complete, for example, factorization of a quite large natural number. Quantum coherence is essentially utilized in all ultrafast quantum algorithms. Therefore, quantum parallel computations with quantum states replacing classical states can achieve an incomparable computation speed and an incomparable information processing function than the classical computers and also save a large amount of computation resources.

Text classification means that a class of a given text (sentence, title, commodity comments, or the like) needs to be inferred, for example, 1) politics, economics, and sports; 2) positive energy and negative energy; and 3) likes, dislikes, etc. Therefore, the corresponding classification forms can be divided into: binary classification, multi-classification, and the like. An application range of text classification is very large, including annotation of junk mails, analysis of e-commerce commodity reviews, title-based annotation of graphic videos, and the like.

Based on the classical computers, each word can generally be embedded into one vector, which is word embedding, and then features are extracted, for inference, from word vectors corresponding to an input text by using a convolutional neural network (CNN), a recurrent neural network (RNN), or a self-attention mechanism.

A parsing-based quantum natural language processing (QNLP) model recently proposed, that is, a DisCoCat model, can run on recent quantum devices for text classification. For text classification, the existing DisCoCat model first parses the given text, then converts the text into a graphic language similar to a tensor network, and then converts the graphic language into a quantum circuit. The quantum circuit is run and measured, and iteratively optimized after being processed by the classical computers, to obtain a result. However, a text classification method based on the DisCoCat model needs to parse the input text, and such a preprocessing process is time-consuming and troublesome and is difficult to implement in practical applications. In addition, the effect is limited, and even for a relatively simple data set, the effect of a simulation experiment is not ideal.

Other existing QNLP models (for example, a language model based on a quantum probability theory) are not models based on quantum circuits. Although a good effect is achieved on some small data sets, the models are hardly applied to recent quantum devices. In addition, the models are only applicable to small data sets and are poor in expandability due to an excessively high dimension.

Text classification is a basic task in the QNLP field. With the quantum computers, quantum advantages are expected to be implemented in the QNLP field.

Embodiments of the present disclosure are described herein in detail in conjunction with the drawings.

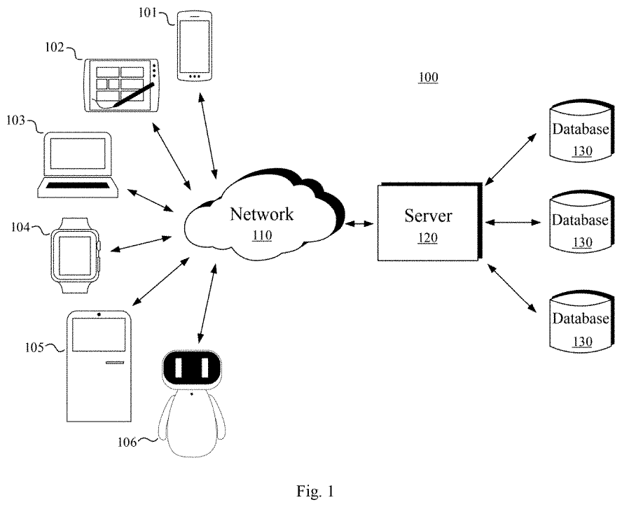

FIG. 1 is a schematic diagram of an system 100 in which various methods and apparatuses described herein can be implemented according to some embodiments of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more application programs.

In some embodiments of the present disclosure, the server 120 can run one or more services or software applications that enable a model training method to be performed.

In some embodiments, the server 120 may further provide other services or software applications that may include a non-virtual environment and a virtual environment. In some embodiments, these services may be provided as web-based services or cloud services, for example, provided to a user of the client device 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client device 101, 102, 103, 104, 105, and/or 106 may sequentially use one or more client application programs to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

The user may use the client device 101, 102, 103, 104, 105, and/or 106 to obtain a training text and the like. The client device may provide an interface that enables the user of the client device to interact with the client device. The client device may also output information to the user via the interface. Although FIG. 1 depicts only six types of client devices, those skilled in the art will understand that any number of client devices are possible in the present disclosure.

The client device 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software application programs and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various application programs, such as various Internet-related application programs, communication application programs (e.g., email application programs), and short message service (SMS) application programs, and can use various communication protocols.

The network 110 may be any type of network understandable by those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above-mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may include one or more application programs to analyze and merge data feeds and/or event updates received from users of the client devices 101, 102, 103, 104, 105, and 106. The server 120 may further include one or more application programs to display the data feeds and/or real-time events via one or more display devices of the client devices 101, 102, 103, 104, 105, and 106.

In some implementations, the server 120 may be a server in a distributed system, or a server combined with a blockchain. The server 120 may also be a cloud server, or an intelligent cloud computing server or intelligent cloud host with artificial intelligence technologies. The cloud server is a host product in a cloud computing service system, which overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as an text file. The databases 130 may reside in various locations. For example, a database used by the server 120 may be locally in the server 120, or may be remote from the server 120 and may communicate with the server 120 via a network-based or dedicated connection. The databases 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application program to store application program data. The database used by the application program may be of different types, for example, may be a key-value repository, an object repository, or a regular repository backed by a file system.

The system 100 of FIG. 1 may be configured and operated in various manners, such that the various methods and apparatuses described according to the present disclosure can be applied.

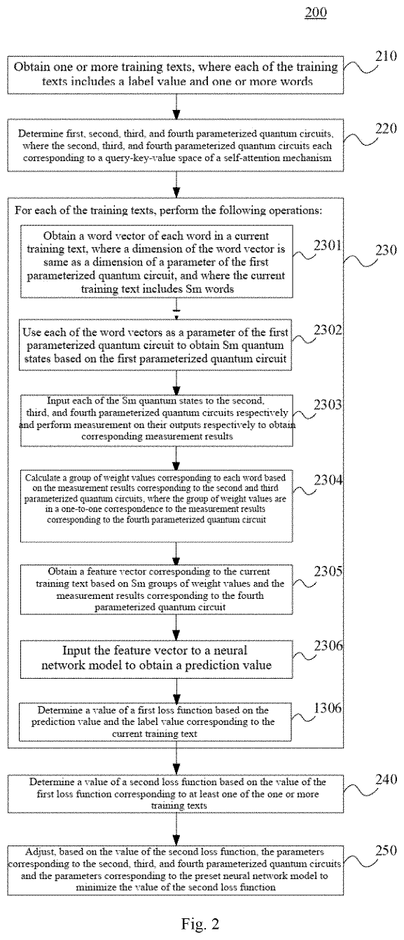

FIG. 2 is a flowchart 200 of a model training method based on parameterized quantum circuits according to some embodiments of the present disclosure. As shown in FIG. 2, the method may include: obtaining one or more training texts, where each of the training texts includes a label value and one or more words (step 210); determining first, second, third, and fourth parameterized quantum circuits, where the second, third, and fourth parameterized quantum circuits respectively correspond to a query-key-value space of a self-attention mechanism (step 220); for each of the one or more training texts, performing the following operations (step 230): obtaining a word vector of each word in a current training text, where a dimension of the word vector is the same as a dimension of a parameter of the first parameterized quantum circuit, and where the current training text includes Sₘ words, and Sₘ is a positive integer (step 2301); using each of the word vectors as a parameter of the first parameterized quantum circuit to obtain Sₘ quantum states based on the first parameterized quantum circuit (step 2302); inputting each of the Sₘ quantum states to the second, third, and fourth parameterized quantum circuits respectively and performing measurement on their outputs respectively to obtain the corresponding measurement results (step 2303); calculating a group of weight values corresponding to each word based on the measurement results corresponding to the second and third parameterized quantum circuits, where the group of weight values are in a one-to-one correspondence to the measurement results corresponding to the fourth parameterized quantum circuit (step 2304); obtaining a feature vector corresponding to the current training text based on Sₘ groups of weight values and the measurement results corresponding to the fourth parameterized quantum circuit (step 2305); inputting the feature vector to a neural network model to obtain a prediction value (step 2306); and determining a value of a first loss function based on the prediction value and the label value corresponding to the current training text (step 2307); determining a value of a second loss function based on the value of the first loss function corresponding to at least one of the one or more training texts (step 240); and adjusting, based on the value of the second loss function, the parameters corresponding to the second, third, and fourth parameterized quantum circuits and the parameters corresponding to the neural network model to minimize the value of the second loss function (step 250).

Some embodiments of the present disclosure fully uses a capability of a self-attention mechanism network and is quite applicable to recent quantum devices with a limited capability; and complex parsing of texts is not needed, and a training process is more direct and efficient. In the present disclosure, the label values of the training texts may be in any form, including but not limited to label values {0, 1} in a binary classification task, label values {0, 1, 2, . . . } in a multi-classification task, and the like.

In some examples, the parameterized quantum circuits U(θ) may generally be composed of a plurality of single-qubit rotation gates and a CNOT gate (controlled NOT gate), where a plurality of rotation angles constitute a vector θ, that is, an adjustable parameter. The parameterized quantum circuits are widely applied to various quantum algorithms, for example, a VQE algorithm for solving minimum energy of a quantum system.

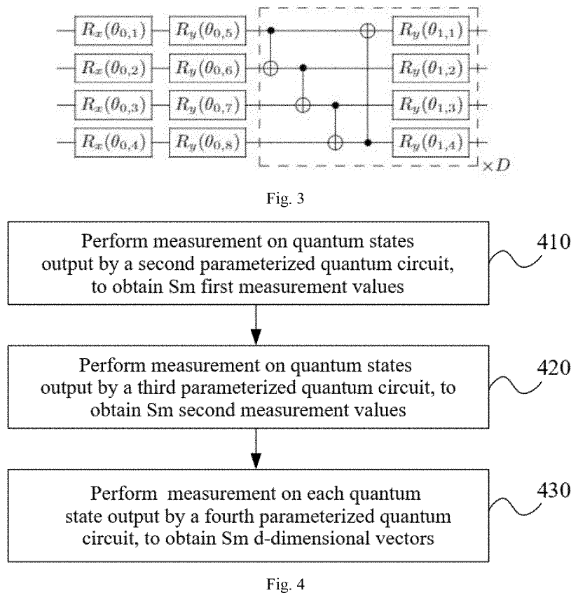

FIG. 3 is a schematic structural diagram of a parameterized quantum circuit according to some embodiments of the present disclosure. As shown in FIG. 3, in order to run in existing quantum computers as much as possible, the parameterized quantum circuit may include only single-qubit rotation gates Rₓ(θ) and R_{y}(θ) in an X direction and a Y direction and two-qubit CNOT gates, where D in FIG. 3 indicates that a part in a dashed box is repeated D times, and D is a positive integer. In a subscript of θ, the first value indicates the number of layers (being repeated D times means D layers), and the second value indicates a parameter index. For example, θ_{1, 2} indicates the second parameter of a first layer. It can indicate that the circuit shown in FIG. 3 has a relatively strong expression capability. Certainly, another appropriate parameterized quantum circuit may also be selected correspondingly based on features and limitations of the quantum computers used, based on various in practical applications.

In some examples, the preset neural network model may be any suitable network model, including but not limited to a fully-connected neural network and the like.

According to this embodiment of the present disclosure, a quantum state corresponding to each word in a training text is obtained by using the first parameterized quantum circuit. Specifically, the word vector of each word is used as a parameter value of the first parameterized quantum circuit, such that the first parameterized quantum circuit acts on an initial quantum state to obtain a quantum state corresponding to each word.

According to some embodiments, an initial state of the first parameterized quantum circuit may be: a uniform superposition state, a |0ⁿ [symbol] state, or the like.

Therefore, according to some embodiments, when the initial state of the first parameterized quantum circuit is the uniform superposition state, the method according to the present disclosure may further include: obtaining a quantum state in a |0ⁿ [symbol] state, where n is the number of qubits, and n is a positive integer; and applying an H gate to the obtained quantum state to obtain the uniform superposition state.

Certainly, it should be understood that initial states in other forms and other methods for obtaining the initial states (for example, the uniform superposition state) are all possible and are not limited herein.

According to some embodiments, the adjusting, based on the second loss function, the parameters corresponding to the second, third, and fourth parameterized quantum circuits and the parameters corresponding to the preset neural network model may include: adjusting, based on the second loss function, the parameters corresponding to the second, third, and fourth parameterized quantum circuits, word vectors of words in the at least one training text, and the parameters corresponding to the preset neural network model. To be specific, the word vectors of the corresponding words can be optimized when the parameters of the parameterized quantum circuits and the parameters of the neural network model are continuously optimized in the training process. In this way, after the training is completed, word vectors of a plurality of words corresponding to training texts can be obtained. The word vectors that are continuously optimized are more applicable to a current learning task, and therefore, a text recognition and classification effect can also be improved.

Therefore, according to some embodiments, the word vector of each word in the current training text may be obtained by performing random initialization. A randomly initialized vector to is used as an initial word vector of a word, and a user can freely select a random initialization method, including but not limited to normal distribution sampling and the like.

According to some embodiments, the word vector of the word in the current training text may alternatively be obtained by using a trained neural network model. The trained neural network model includes but is not limited to a Word2Vec model, a GloVe model, and the like.

It can be understood that if the training text is sufficiently rich, after the training process is completed, sufficient trained word vectors are obtained. In a subsequent application process, the word vectors of conventional words are generally obtained through training. If a new word appears in a few cases, a word vector of the new word may be obtained by using another suitable method (for example, by using the trained neural network model) and used as a parameter of a parameterized quantum circuit to obtain a corresponding quantum state.

The self-attention mechanism means screening few critical information from a large amount of information and focus on the critical information, and is good at capturing internal correlation of data or features. According to some embodiments of the present disclosure, a long-term dependency problem is solved based on the self-attention mechanism by calculating correlation among the words, including: first mapping word vectors to a query-key-value space based on the word vectors, then calculating a score for each value vector, and finally performing weighted summation on values based on scores corresponding to the values to obtain an output vector. According to some embodiments of the present disclosure, the second, third, and fourth parameterized quantum circuits respectively correspond to the query-key-value space of the self-attention mechanism and are used to determine mapping of the word vector of each word to the query-key-value space based on the quantum state corresponding to the word vector of the word.

According to some embodiments, as shown in FIG. 4, the inputting each of the Sₘ quantum states to the second, third, and fourth parameterized quantum circuits and performing measurement may include: performing measurement operations on quantum states output by the second parameterized quantum circuit, to obtain Sₘ first measurement values (step 410); performing measurement operations on quantum states output by the third parameterized quantum circuit, to obtain Sₘ second measurement values (step 420); and performing d measurement operations on each quantum state output by the fourth parameterized quantum circuit, to obtain d-dimensional vectors (step 430). Any two values in each of the Sₘ d-dimensional vectors are different, where d is a dimension of the word vector.

According to some embodiments, the measurement operations may include one or more of the following: Pauli X measurement, Pauli Y measurement, and Pauli Z measurement. In this embodiment, classical information is extracted from the quantum states by using Pauli measurement to perform subsequent operations. In practical applications, suitable Pauli measurement may be selected according to limitations of a quantum device, including Pauli X measurement, Pauli Y measurement, and Pauli Z measurement. It can be understood that another measurement more convenient on the device in use may alternatively be selected and is not limited herein.

In some embodiments, d measurement operations are performed on each quantum state output by the fourth parameterized quantum circuit, to obtain Sₘ d-dimensional vectors. The parameterized quantum circuit herein may be an n-qubit circuit, and therefore, the fourth parameterized quantum circuit outputs quantum states of n qubits. Any of the d measurement operations may be performed on the output quantum states of n qubits, including Pauli X measurement, Pauli Y measurement, and Pauli Z measurement, where different measurement operations may be performed on different qubits in a same quantum state, such that values in the obtained d-dimensional vectors are different.

According to some embodiments, the calculating one group of weight values corresponding to each word based on the measurement results corresponding to the second and third parameterized quantum circuits includes: for each of the Sₘ first measurement values: sequentially combining the current first measurement value with each of the Sₘ second measurement values, and performing Gaussian kernel estimation based on the combined first measurement value and second measurement value, to obtain estimation values; and normalizing the obtained estimation values to obtain a group of weight values corresponding to a first word. The first word is a corresponding word in the current training text corresponding to the current first measurement value.

According to some embodiments, the parameterized quantum circuits that can absolutely be provided by the recent quantum computer are used as a quantum corresponding version of query-key-value in the self-attention mechanism, and the measurement results of these circuits are post-processed to serve as quantum value vectors and corresponding scores (weights) thereof, and then “weighted summation” is performed as in the classical case. Specifically, in this embodiment, a projected quantum kernel estimation method, that is, a Gaussian kernel estimation method, is used to calculate the weight values.

For example, Sₘ measurement results of the second parameterized quantum circuit and Sₘ measurement results of the third parameterized quantum circuit are combined pairwise to form Sₘ×Sₘ combinations. The projected quantum kernel (that is, Gaussian kernel) estimation is performed on two measurement results in each combination to obtain the group of weight values corresponding to each word.

In the foregoing embodiment, the projected quantum kernel is experimentally proved effective when used to calculate a quantum self-attention matrix, and this can achieve a better effect in some practical applications with quantum advantages of the projected quantum kernel.

Certainly, the group of weight values corresponding to each word may alternatively be obtained by using a classical dot product operation method.

Therefore, according to some embodiments, the calculating one group of weight values corresponding to each word based on the measurement results corresponding to the second and third parameterized quantum circuits includes: for each of the Sₘ first measurement values:

sequentially combining the current first measurement value with each of the Sₘ second measurement values, and performing a dot product operation based on the combined first measurement value and second measurement value, to obtain estimation values; and normalizing the obtained estimation values to obtain a group of weight values corresponding to a first word. The first word is a corresponding word in the current training text corresponding to the current first measurement value.

According to some embodiments of the present disclosure, at step 1, N training texts are obtained, where each of the training texts includes a label and one or more words, and N is a positive integer. It is assumed that the m^{th} training text includes Sₘ words {x₁^{(m)}, x₂^{(m)}, . . . , x_{S}_{ₘ}^{(m)}}, and a label of the training text is y^{(m)}∈{0, 1}. Then, N training texts may form a training data set:

[symbol]

={(x₁^{(m)},x₂^{(m)}, . . . ,x_{S}_{ₘ}^{(m)}),y^{(m)}}ₘ₌₁^{N}

At step 2, for all words in the N training texts, each word x is embedded into a randomly initialized d-dimensional vector to obtain a word vector ω∈ [symbol] ^{d}. In addition, one n (positive integer)-qubit parameterized quantum circuit U_{ebd}(θ) (used as the first parameterized quantum circuit) is prepared to encode word vectors into quantum states, where θ indicates a vector constituted by all the d parameters in the circuit. In addition, three n-qubit parameterized quantum circuits U_{q}(θ_{q}), Uₖ(θₖ), Uᵥ(θᵥ) (used as the second, third, and fourth parameterized quantum circuits respectively) are then prepared to serve as quantum corresponding versions of query-key-value in the self-attention mechanism, where θ_{q}, θₖ, θᵥ indicate parameters of the three circuits respectively.

At step 3, for the m^{th} training text in a training set [symbol] , a word vector wᵢ^{(m)} corresponding to each word xᵢ^{(m)} is used as a parameter of the quantum circuit U_{ebd} to obtain a parameterized quantum circuit U_{ebd}(ωᵢ^{(m)}), and a uniform superposition state is used as the initial state of the circuit to finally obtain Sₘ quantum states {|ψᵢ [symbol] =U_{ebd}(ωᵢ^{(m)})H^{⊗n}|0ⁿ [symbol] }. Herein, H is a Hadamard gate that has an effect of converting a |0ⁿ [symbol] state (default initial state) into the uniform superposition state.

At step 4, each quantum state |ψᵢ [symbol] in the Sₘ quantum states obtained above is input to each of quantum circuits U_{q}(θ_{q}), Uₖ(θₖ), Uᵥ(θᵥ). Then, measurement operations (for example, Pauli Z measurement) are performed on the quantum states output by the first two quantum circuits U_{q}(θ_{q}), Uₖ(θₖ) to obtain measurement results [symbol] Z_{q} [symbol] ᵢ, [symbol] Zₖ [symbol] ᵢ respectively. On each quantum state output by the third quantum circuit Uᵥ(θᵥ), d different measurement operations are performed. A vector constituted by the d measurement results is denoted as oᵢ∈ [symbol] ^{d}.

At step 5, the measurement results [symbol] Z_{q} [symbol] ₛ, [symbol] Zₖ [symbol] ⱼ corresponding to the quantum circuits U_{q}(θ_{q}), Uₖ(θₖ) respectively are combined pairwise, projected quantum kernel (Gaussian kernel) estimation is performed based on the combined measurement results to obtain \tilde{α}_{s,j}, and normalization is performed on each row to obtain \tilde{α}_{s,j}, that is,

$${α}_{s , j} = \frac{{\tilde{α}}_{s , j}}{{\sum }_{i = 1}^{{S}_{m}} {\tilde{α}}_{s , i}} \\ {\tilde{α}}_{s , j} = {e}^{- {( {〈 {Z}_{q} 〉}_{s} - {〈 {Z}_{k} 〉}_{j} )}^{2}}$$

Herein, all the \tilde{α}_{s,j} constitute a quantum self-attention matrix α.

At step 6, for the s^{th} (s=1, 2, . . . , Sₘ) quantum state |ψₛ [symbol] in the Sₘ quantum states obtained at step 3, “weighted summation” is performed on the third measurement results oⱼ of all the quantum states are by a coefficient α, and finally the word vector ωₛ^{(m)} of |ψₛ [symbol] is added to obtain an output.

$${y}_{s} = {ω}_{s}^{( m )} + {\sum }_{j = 1}^{{S}_{m}} {α}_{s , j} \cdot {o}_{j}$$

It can be understood that “weighted summation” can be directly performed on the third measurement results oⱼ of all the quantum states herein by the coefficient α to obtain the output yₛ, meaning that the word vector ωₛ^{(m)} of |ψₛ [symbol] does not need to be added. The word vector wₛ^{(m)} of |ψₛ [symbol] can be added herein to avoid a vanishing gradient problem in some cases.

At step 7, the output vectors of all the foregoing quantum states can be averaged to obtain:

$${\overline{y}}^{( m )} = \frac{1}{{S}_{m}} {\sum }_{s = 1}^{{S}_{m}} {y}_{s}$$

Then, the average is input to a preset fully-connected neural network to obtain a loss function:

$${L}^{( m )} = {\frac{1}{2} [ σ ( {w}^{T} \cdot {\overline{y}}^{( m )} + b ) - {y}^{( m )} ]}^{2}$$

Herein, σ(·) is a Logistic function, w, b is a parameter of the fully-connected neural network, and σ(w^{T}·y̅^{(m)}+b) is a prediction value output by a model constituted by the parameterized quantum circuits and the fully-connected neural network.

At step 8, for all the N input texts in the training data set, steps 3 to 6 are repeatedly performed to obtain a loss function:

$$L = \frac{1}{N} {\sum }_{m = 1}^{N} {L}^{( m )}$$

At step 9, the parameters {θ_{q}, θₖ, θᵥ} in the parameterized quantum circuits and the parameters w, b in the fully-connected neural network and the word vectors {ωᵢ^{(m)}} are adjusted by using a gradient descent method or another optimization method, and steps 1 to 8 are repeatedly performed to minimize the loss function to obtain optimal parameters.

At step 10, the optimal parameters are finally used, and σ(w^{T}·y̅+b) is output by the model (that is, to determine whether it tends to 0 or 1 for classification). In some examples, classification accuracy may be further tested based on a test data set.

It should be noted that parameter adjustment and optimization may alternatively be performed herein by using, for example, a stochastic gradient descent method. That is, training may be performed in units of one or more texts. For example, L^{(m)} can be used as a corresponding loss function to adjust the parameters {θ_{q}, θₖ, θᵥ} in the parameterized quantum circuits and the parameters w, b in the fully-connected neural network and a word vector {ωᵢ^{(m)}} corresponding to the m^{th} text. After the current text is trained, the method proceeds to train the next text.

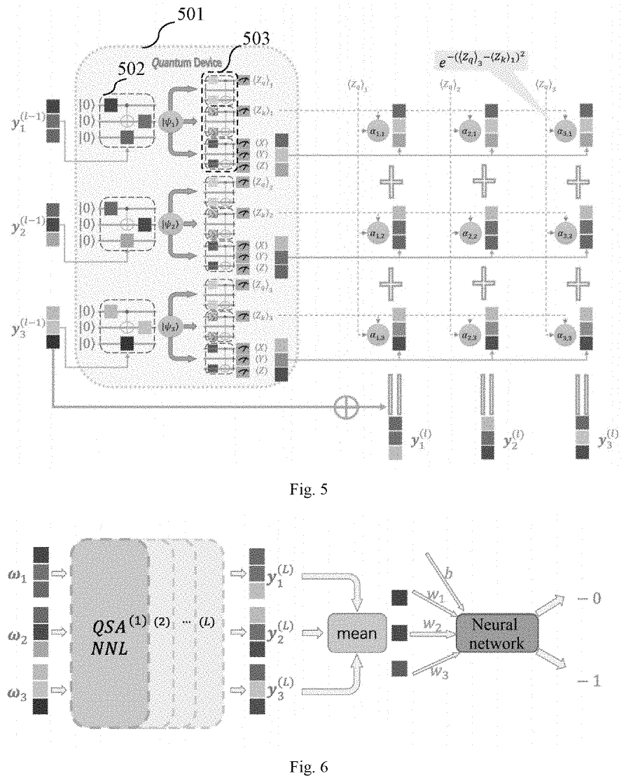

FIG. 5 is a schematic diagram of obtaining corresponding feature vectors based on word vectors according to some embodiments of the present disclosure. As shown in FIG. 5, a current training text includes three words, where word vectors corresponding to the words are y₁^{(l-1)}, y₂^{(l-1)}, and y₃^{(l-1)} respectively, and the word vectors are three-dimensional vectors and correspond to three rectangular blocks. Each word vector is input to a quantum device (that is, a quantum computer) 501 to obtain corresponding quantum states |ψ₁ [symbol] , |ψ₂ [symbol] , and |ψ₃ [symbol] by using a first parameterized quantum circuit 502. The quantum states |ψ₁ [symbol] , |ψ₂ [symbol] , and |ψ₃ [symbol] pass through second, third, and fourth parameterized quantum circuits (sequentially arranged from top to bottom in box 503) respectively to obtain corresponding measurement results: [symbol] Z_{q} [symbol] ₛ, [symbol] Zₖ [symbol] ⱼ (s,j=1,2,3) and three-dimensional vectors. A corresponding quantum self-attention matrix α is obtained through projected quantum kernel estimation, such that “weighted summation” is performed on third measurement results in all the quantum states by a coefficient α, and finally an original word vector is added to obtain an output.

As described herein, for each word, an output vector is finally obtained starting from the initial word vector, and this process can be considered as a single-layer quantum self-attention network. In some embodiments, a multi-layer quantum self-attention network may alternatively be used to improve an effect, that is, the output vector y obtained on a previous layer is used as an initial word vector of words on a next layer. As shown in FIG. 6, the single-layer quantum self-attention network QSANNL indicates the process shown in FIG. 5. In FIGS. 6, y₁^{(L)}, y₂^{(L)}, and y₃^{(L)} output by a multi-layer quantum self-attention network are averaged to obtain a mean, and the mean is input to a neural network, where parameters of the neural network include w₁, w₂, w₃, b. A classification result output by the neural network is 0 or 1.

In some examples, through simulation experiments on existing MC (Meaning Classification for determining whether a sentence belongs to an IT class or a food class) and RP (RelPron for determining whether a sentence includes a subject relative clause or an object relative clause) data sets, it is found that the method can achieve higher precision at lower costs (that is, by using a smaller number of parameters) than a DisCoCat method. Details are shown in Table 1. It sufficiently indicates that the method according to the present disclosure is lower in costs, easier to implement and better in effect. It should be noted that on the RP data set, test precision of the method according to the present disclosure is not higher than that of the original method, mainly because a great offset exists between a training set and a test set of the data set, that is, almost a half of the words in the test set are absent in the training set. Therefore, the two methods are both relatively low in test precision. However, in terms of training precision of the training set, this solution is far higher than the original method.

TABLE 1

| | MC data set | | | RP data set | | |
|---|---|---|---|---|---|---|
| | Number of | Training | Test | Number of | Training | Test |
| Methods | parameters | precision % | precision % | parameters | precision % | precision % |
| DisCoCat | 40 | 83.10 | 79.80 | 168 | 90.60 | 72.30 |
| Embodiments | 23 | 100.00 | 100.00 | 109 | 95.35 | 67.74 |
| according to | | | | | | |
| the present | | | | | | |
| disclosure | | | | | | |

Therefore, according to some embodiments of the present disclosure, complex parsing does not need to be performed on texts as the DisCoCat model, only a word vector of each word needs to be obtained, and the process is more direct and efficient. The parameterized quantum circuits used are quite simple, quite applicable to the recent quantum device, free of impact of sentence length on expandability, wide in application range, and low in costs.

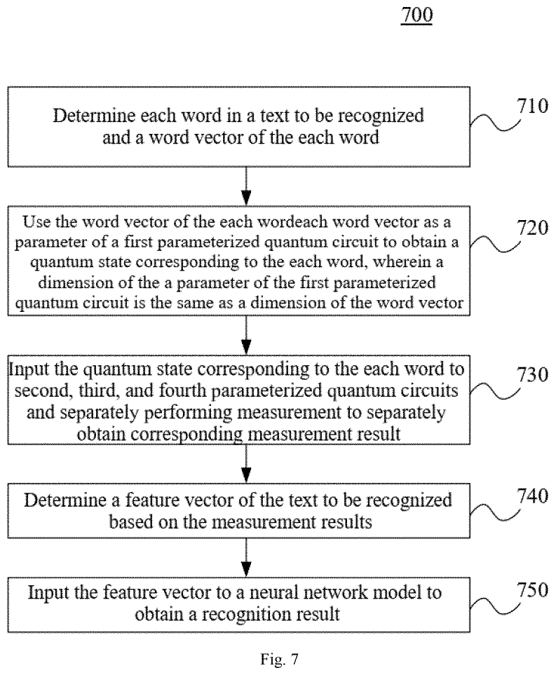

According to some embodiments of the present disclosure, as shown in FIG. 7, there is further provided a text recognition method 700, including: determining each word in a text to be recognized and a word vector of the word (step 710); using each word vector as a parameter of a first parameterized quantum circuit to obtain a quantum state corresponding to each word, where a dimension of the parameter of the first parameterized quantum circuit is the same as a dimension of the word vector (step 720); inputting each quantum state to second, third, and fourth parameterized quantum circuits and separately performing measurement to separately obtain corresponding measurement results (step 730); determining a feature vector of the text to be recognized based on the measurement results (step 740); and inputting the feature vector to a neural network model to obtain a recognition result (step 750). The second, third, and fourth parameterized quantum circuits and the neural network model are trained by using the method according to any one of the foregoing embodiments.

According to some embodiments, at least one of the word vectors is trained by using the method according to any one of the foregoing embodiments.

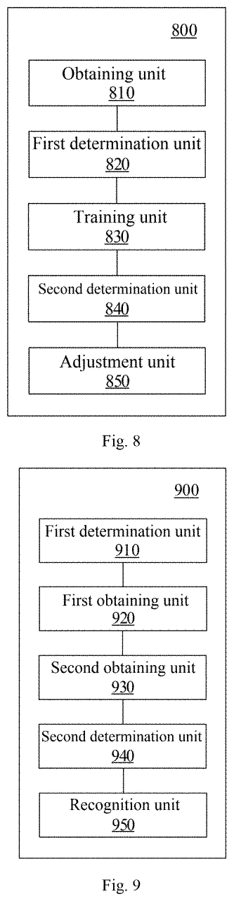

According to some embodiments of the present disclosure, as shown in FIG. 8, there is further provided a model training apparatus 800 based on parameterized quantum circuits, the apparatus including: an obtaining unit 810 configured to obtain one or more training texts, where each of the training texts includes a label value and one or more words; a first determination unit 820 configured to determine first, second, third, and fourth parameterized quantum circuits, where the second, third, and fourth parameterized quantum circuits each correspond to a query-key-value space of a self-attention mechanism; a training unit 830 configured to: for each of the training texts, perform the following operations: obtaining a word vector of each word in the current training text, where a dimension of the word vector is the same as a dimension of a parameter of the first parameterized quantum circuit, and where the current training text includes Sₘ words, and Sₘ is a positive integer; using each of the word vectors as a parameter of the first parameterized quantum circuit to obtain Sₘ quantum states based on the first parameterized quantum circuit; inputting each of the Sₘ quantum states to the second, third, and fourth parameterized quantum circuits and performing measurement to separately obtain corresponding measurement results; calculating one group of weight values corresponding to each word based on the measurement results corresponding to the second and third parameterized quantum circuits, where the group of weight values are in a one-to-one correspondence to the measurement results corresponding to the fourth parameterized quantum circuit; obtaining feature vectors corresponding to the current training text based on Sₘ groups of weight values and the measurement results corresponding to the fourth parameterized quantum circuit; inputting the feature vectors to a preset neural network model to obtain a prediction value; and determining a first loss function based on the prediction value and the label value corresponding to the current training text; a second determination unit 840 configured to determine a second loss function based on the first loss function corresponding to at least one of the one or more training texts; and an adjustment unit 850 configured to adjust, based on the second loss function, the parameters corresponding to the second, third, and fourth parameterized quantum circuits and the parameters corresponding to the preset neural network model to minimize the corresponding first loss function.

Herein, operations of all the foregoing units 810 to 850 of the model training apparatus 800 based on parameterized quantum circuits are similar to operations of steps 210 to 250 described above. Details are not described herein again.

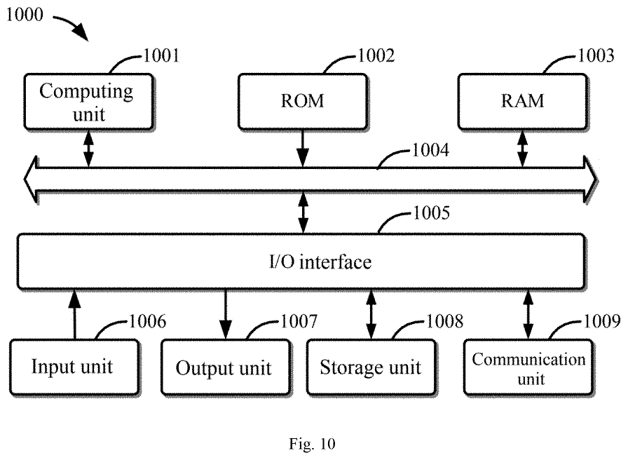

According to some embodiments of the present disclosure, as shown in FIG. 9, there is further provided a text recognition apparatus 900, including: a first determination unit 910 configured to determine each word in a text to be recognized and a word vector of the word; a first obtaining unit 920 configured to use each word vector as a parameter of a first parameterized quantum circuit to obtain a quantum state corresponding to each word, where a dimension of the parameter of the first parameterized quantum circuit is the same as a dimension of the word vector; a second obtaining unit 930 configured to input each quantum state to second, third, and fourth parameterized quantum circuits and separately perform measurement to separately obtain corresponding measurement results; a second determination unit 940 configured to determine a feature vector of the text to be recognized based on the measurement results; and a recognition unit 950 configured to input the feature vector to a neural network model to obtain a recognition result. The second, third, and fourth parameterized quantum circuits and the neural network model are trained by using the method according to any one of the foregoing embodiments.

In the technical solutions of the present disclosure, collecting, storage, use, processing, transmitting, providing, disclosing, etc. of personal information of a user involved all comply with related laws and regulations and are not against the public order and good morals.

According to some embodiments of the present disclosure, there are further provided an electronic device, a readable storage medium, and a computer program product.

Referring to FIG. 10, a structural block diagram of an electronic device 1000 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 10, the device 1000 includes a computing unit 1001, which may perform various appropriate actions and processing according to a computer program stored in a read-only memory (ROM) 1002 or a computer program loaded from a storage unit 1008 to a random access memory (RAM) 1003. The RAM 1003 may further store various programs and data required for the operation of the device 1000. The computing unit 1001, the ROM 1002, and the RAM 1003 are connected to each other through a bus 1004. An input/output (I/O) interface 1005 is also connected to the bus 1004.

A plurality of components in the device 1000 are connected to the I/O interface 1005, including: an input unit 1006, an output unit 1007, the storage unit 1008, and a communication unit 1009. The input unit 1006 may be any type of device capable of entering information to the device 1000. The input unit 1006 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1007 may be any type of device capable of presenting information, and may include, but is not limited to, a display, a speaker, a video/audio output terminal, a vibrator, and/or a printer. The storage unit 1008 may include, but is not limited to, a magnetic disk and an optical disc. The communication unit 1009 allows the device 1000 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 802.11 device, a Wi-Fi device, a WiMax device, a cellular communication device, and/or the like.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1001 performs the various methods and processing described above, for example, the method 200 or 700. For example, in some embodiments, the method 200 or 700 may be implemented as a computer software program, which is tangibly contained in a machine-readable medium, such as the storage unit 1008. In some embodiments, a part or all of the computer program may be loaded and/or installed onto the device 1000 via the ROM 1002 and/or the communication unit 1009. When the computer program is loaded onto the RAM 1003 and executed by the computing unit 1001, one or more steps of the method 200 or 700 described above can be performed. Alternatively, in other embodiments, the computing unit 1001 may be configured, by any other suitable means (for example, by means of firmware), to perform the method 200 or 700.

Various implementations of the systems and technologies described herein can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although some embodiments or examples of the present disclosure have been described with reference to the drawings, it should be appreciated that the methods, systems, and devices described above are merely embodiments or examples, and the scope of the present invention is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A model training method, comprising:
obtaining one or more training texts, wherein each of the training texts comprises a label value and one or more words;
determining a first parameterized quantum circuit, a second parameterized quantum circuit, a third parameterized quantum circuit, and a fourth parameterized quantum circuit, the second parameterized quantum circuit, the third parameterized quantum circuit, and the fourth parameterized quantum circuit each corresponding to a query-key-value space of a self-attention mechanism;
for each of the one or more training texts, performing operations including:
obtaining a word vector of each word in a current training text, wherein a dimension of the word vector is same as a dimension of a parameter of the first parameterized quantum circuit, and wherein the current training text comprises Sₘ words, and Sₘ is a positive integer;
using each of the word vectors as a parameter of the first parameterized quantum circuit to obtain Sₘ quantum states based on the first parameterized quantum circuit;
inputting each of the Sₘ quantum states to the second, third, and fourth parameterized quantum circuits respectively and performing measurement on their outputs respectively to obtain corresponding measurement results;
calculating a group of weight values corresponding to each word based on the measurement results corresponding to the second and third parameterized quantum circuits, wherein the group of weight values are in a one-to-one correspondence to the measurement results corresponding to the fourth parameterized quantum circuit;
obtaining a feature vector corresponding to the current training text based on Sₘ groups of weight values and the measurement results corresponding to the fourth parameterized quantum circuit;
inputting the feature vector to a neural network model to obtain a prediction value; and
determining a value of a first loss function based on the prediction value and the label value corresponding to the current training text;
determining a value of a second loss function based on the value of the first loss function corresponding to at least one of the one or more training texts; and
adjusting, based on the value of the second loss function, the parameters corresponding to the second, third, and fourth parameterized quantum circuits and the parameters corresponding to the neural network model to minimize the value of the second loss function.

2. The method according to claim 1, wherein the adjusting, based on the value of the second loss function, the parameters corresponding to the second, third, and fourth parameterized quantum circuits and the parameters corresponding to the neural network model comprises:
adjusting, based on the value of the second loss function, the parameters corresponding to the second, third, and fourth parameterized quantum circuits, the word vector of a word in the at least one training text, and the parameters corresponding to the preset neural network model.

3. The method according to claim 1, wherein the obtaining a word vector of each word in the current training text comprises: obtaining the word vector of the word in the current training text by performing random initialization.

4. The method according to claim 1, wherein the obtaining a word vector of each word in the current training text comprises: obtaining the word vector of the word in the current training text by using a trained neural network model.

5. The method according to claim 1, wherein the inputting each of the Sₘ quantum states to the second, third, and fourth parameterized quantum circuits comprises:
performing measurement on quantum states output by the second parameterized quantum circuit, to obtain Sₘ first measurement values;
performing measurement on quantum states output by the third parameterized quantum circuit, to obtain Sₘ second measurement values; and
performing d measurement on each quantum state output by the fourth parameterized quantum circuit, to obtain Sₘ d-dimensional vectors,
wherein any two values in each of the d-dimensional vectors are different, where d is a positive integer.

6. The method according to claim 5, wherein the measurement comprises one or more of: Pauli X measurement, Pauli Y measurement, or Pauli Z measurement.

7. The method according to claim 5, wherein the calculating one group of weight values corresponding to each word based on the measurement results corresponding to the second and third parameterized quantum circuits comprises:
for each of the Sₘ first measurement values:
sequentially combining a current first measurement value with each of the Sₘ second measurement values to obtain combined values, and performing Gaussian kernel estimation based on the combined values, to obtain estimation values; and
normalizing the obtained estimation values to obtain a group of weight values corresponding to a first word,
wherein the first word is a corresponding word in the current training text corresponding to the current first measurement value.

8. The method according to claim 5, wherein the calculating one group of weight values corresponding to each word based on the measurement results corresponding to the second and third parameterized quantum circuits comprises:
for each of the Sₘ first measurement values:
sequentially combining a current first measurement value with each of the Sₘ second measurement values to obtain combined values, and performing a dot product operation based on the combined values, to obtain estimation values; and
normalizing the obtained estimation values to obtain a group of weight values corresponding to a first word,
wherein the first word is a corresponding word in the current training text corresponding to the current first measurement value.

9. The method according to claim 1, wherein initial states of the first parameterized quantum circuit comprise one or more of: a uniform superposition state or a |0ⁿ [symbol] state.

10. The method according to claim 1, wherein in response to an initial state of the first parameterized quantum circuit being a uniform superposition state, the method further comprises:
obtaining a quantum state in a |θⁿ [symbol] state, where n is a number of qubits, and n is a positive integer; and
applying an H gate to the obtained quantum state to obtain a uniform superposition state.

11. A text recognition method, comprising:
determining each word in a text to be recognized and a word vector of the each word;
using the word vector of the each word as a parameter of a first parameterized quantum circuit to obtain a quantum state corresponding to the each word, wherein a dimension of a parameter of the first parameterized quantum circuit is same as a dimension of the word vector;
inputting the quantum state corresponding to the each word to a second parameterized quantum circuit, a third parameterized quantum circuit, and a fourth parameterized quantum circuit and separately performing measurement to separately obtain corresponding measurement result;
determining a feature vector of the text to be recognized based on the measurement results; and
inputting the feature vector to a neural network model to obtain a recognition result, wherein
the second, third, and fourth parameterized quantum circuits and the neural network model are trained by first operations including:
obtaining one or more training texts, wherein each of the training texts comprises a label value and one or more words;
determining the first, second, third, and fourth parameterized quantum circuits, wherein the second, third, and fourth parameterized quantum circuits each correspond to a query-key-value space of a self-attention mechanism;
for each of the one or more training texts, performing second operations including:
obtaining a word vector of each word in a current training text, wherein a dimension of the word vector is same as a dimension of a parameter of the first parameterized quantum circuit, and wherein the current training text comprises Sₘ words, and Sₘ is a positive integer;
using each of the word vectors as a parameter of the first parameterized quantum circuit to obtain Sₘ quantum states based on the first parameterized quantum circuit;
inputting each of the Sₘ quantum states to the second, third, and fourth parameterized quantum circuits respectively and performing measurement on their outputs respectively to obtain corresponding measurement results;
calculating a group of weight values corresponding to each word based on the measurement results corresponding to the second and third parameterized quantum circuits, wherein the group of weight values are in a one-to-one correspondence to the measurement results corresponding to the fourth parameterized quantum circuit;
obtaining a feature vector corresponding to the current training text based on Sₘ groups of weight values and the measurement results corresponding to the fourth parameterized quantum circuit;
inputting the feature vector to a neural network model to obtain a prediction value; and
determining a value of a first loss function based on the prediction value and the label value corresponding to the current training text;
determining a value of a second loss function based on the value of the first loss function corresponding to at least one of the one or more training texts; and
adjusting, based on the value of the second loss function, the parameters corresponding to the second, third, and fourth parameterized quantum circuits and the parameters corresponding to the neural network model to minimize the value of the second loss function.

12. An electronic device, comprising:
a memory storing one or more programs configured to be executed by one or more processors, the one or more programs including instructions for causing the electronic device to perform operations comprising:
obtaining one or more training texts, wherein each of the training texts comprises a label value and one or more words;
determining a first parameterized quantum circuit, a second parameterized quantum circuit, a third parameterized quantum circuit, and a fourth parameterized quantum circuit, the second parameterized quantum circuit, the third parameterized quantum circuit, and the fourth parameterized quantum circuit each corresponding to a query-key-value space of a self-attention mechanism;
for each of the one or more training texts, performing operations including:
obtaining a word vector of each word in a current training text, wherein a dimension of the word vector is same as a dimension of a parameter of the first parameterized quantum circuit, and wherein the current training text comprises Sₘ words, and Sₘ is a positive integer;
using each of the word vectors as a parameter of the first parameterized quantum circuit to obtain Sₘ quantum states based on the first parameterized quantum circuit;
inputting each of the Sₘ quantum states to the second, third, and fourth parameterized quantum circuits respectively and performing measurement on their outputs respectively to obtain corresponding measurement results;
calculating a group of weight values corresponding to each word based on the measurement results corresponding to the second and third parameterized quantum circuits, wherein the group of weight values are in a one-to-one correspondence to the measurement results corresponding to the fourth parameterized quantum circuit;
obtaining a feature vector corresponding to the current training text based on Sₘ groups of weight values and the measurement results corresponding to the fourth parameterized quantum circuit;
inputting the feature vector to a neural network model to obtain a prediction value; and
determining a value of a first loss function based on the prediction value and the label value corresponding to the current training text;
determining a value of a second loss function based on the value of the first loss function corresponding to at least one of the one or more training texts; and
adjusting, based on the value of the second loss function, the parameters corresponding to the second, third, and fourth parameterized quantum circuits and the parameters corresponding to the neural network model to minimize the value of the second loss function.

13. The electronic device of claim 12, wherein the adjusting, based on the value of the second loss function, the parameters corresponding to the second, third, and fourth parameterized quantum circuits and the parameters corresponding to the neural network model comprises:
adjusting, based on the value of the second loss function, the parameters corresponding to the second, third, and fourth parameterized quantum circuits, the word vector of a word in the at least one training text, and the parameters corresponding to the preset neural network model.

14. The electronic device according to claim 12, wherein the obtaining a word vector of each word in the current training text comprises: obtaining the word vector of the word in the current training text by performing random initialization.

15. The electronic device according to claim 12, wherein the obtaining a word vector of each word in the current training text comprises: obtaining the word vector of the word in the current training text by using a trained neural network model.

16. The electronic device according to claim 12, wherein the inputting each of the Sₘ quantum states to the second, third, and fourth parameterized quantum circuits comprises:
performing measurement on quantum states output by the second parameterized quantum circuit, to obtain Sₘ first measurement values;
performing measurement on quantum states output by the third parameterized quantum circuit, to obtain Sₘ second measurement values; and
performing d measurement on each quantum state output by the fourth parameterized quantum circuit, to obtain Sₘ d-dimensional vectors,
wherein any two values in each of the d-dimensional vectors are different, where d is a positive integer.

17. The electronic device according to claim 16, wherein the measurement comprises one or more of: Pauli X measurement, Pauli Y measurement, or Pauli Z measurement.

18. The electronic device according to claim 16, wherein the calculating one group of weight values corresponding to each word based on the measurement results corresponding to the second and third parameterized quantum circuits comprises:
for each of the Sₘ first measurement values:
sequentially combining a current first measurement value with each of the Sₘ second measurement values to obtain combined values, and performing Gaussian kernel estimation based on the combined values, to obtain estimation values; and
normalizing the obtained estimation values to obtain a group of weight values corresponding to a first word,
wherein the first word is a corresponding word in the current training text corresponding to the current first measurement value.

19. The electronic device according to claim 16, wherein the calculating one group of weight values corresponding to each word based on the measurement results corresponding to the second and third parameterized quantum circuits comprises:
for each of the Sₘ first measurement values:
sequentially combining a current first measurement value with each of the Sₘ second measurement values to obtain combined values, and performing a dot product operation based on the combined values, to obtain estimation values; and
normalizing the obtained estimation values to obtain a group of weight values corresponding to a first word,
wherein the first word is a corresponding word in the current training text corresponding to the current first measurement value.

20. The electronic device according to claim 12, wherein initial states of the first parameterized quantum circuit comprise one or more of: a uniform superposition state or a |0ⁿ [symbol] state.
